(19) United States
(12) Patent Application Publication
(10) Pub. No.: US 2013/0318535 A1
(43) Pub. Date: Nov. 28, 2013

(54) PRIMARY-BACKUP BASED FAULT TOLERANT METHOD FOR MULTIPROCESSOR SYSTEMS

(71) Applicant: Wei Sun, Tokyo (JP)

(72) Inventor: Wei Sun, Tokyo (JP)

(73) Assignee: NEC CORPORATION, Minato-ku, Tokyo (JP)

(21) Appl. No.: 13/814,977

(22) PCT Filed: Jul. 29, 2011
(86) PCT No.: PCT/JP2011/067918

§ 371 Date: Aug. 15, 2013

(30) Foreign Application Priority Data
Aug. 11, 2010 (JP) 2010-180330

(51) Int. Cl. G06F 9/50

(52) U.S. Cl. CPC G06F 9/50
USPC 718/104

(57) ABSTRACT

A method of fault tolerance in a multiprocessor system based on primary-backup scheme includes: receiving a task to be allocated to a processor in a multiprocessor system; allocating a primary version of the task according to a normal real-time scheduling algorithm; checking validity of the allocation of the primary version of the task; allocating a backup version of the task with overloading; and checking validity of the allocation of the backup version of the task.

### TECHNICAL FIELD

The present invention relates to a primary-backup based fault tolerant method for multiprocessor systems. More particularly, the present invention relates to a method for generating fault tolerant task schedules based on existing real-time task scheduling algorithms and to a multiprocessor system performing such a fault tolerant method.

### BACKGROUND ART

Due to the critical nature of tasks in real-time applications, it is essential that every task admitted in a system completes its execution even in the presence of faults. Therefore, fault tolerance is an important requirement for real-time task systems. Fault-tolerance can be provided by hardware or software approaches [1]. The approaches by hardware usually add a heavy burden of cost and energy to system designers. Hence, software approaches, such as fault-tolerant system planning or scheduling, are preferred in some cases especially those where reliability is not very critical, such as in soft-real-time task systems.

Scheduling multiple versions of tasks on different processors is able to provide fault-tolerance, for example in [2] where processor failures are handled by maintaining contingency or backup schedules. These schedules are used in the event of a processor failure. To generate the backup schedule, it is assumed that an optimal schedule exists and the schedule is enhanced with the addition of “ghost” tasks, which function primarily as standby tasks. Although this scheme has been deemed to be optimistic since not all schedules will permit such additions, it is still meaningful that fault-tolerance is not strongly coupled to creating optimal schedules, i.e., optimal schedules created by any possible scheduling algorithm.

In recent decades, one of important fault-tolerant approaches used for real-time task scheduling is the primary-backup model, in which two versions of a task are scheduled on two different processors [3]-[9]. The backup version is executed only if the primary version fails, otherwise it is de-allocated from the schedule if the primary version completes safely. In a schedule based on the primary-backup scheme, the backup versions must compete for time-space resource with the primary versions. Along with the primary-backup scheme, a class of overloading techniques have also come into being, and in overloading techniques a task is allowed to share the same time slot with another task in a fault tolerant schedule.

To improve schedulability, backup-backup (BB) overloading is employed [4]-[6]. Backup-backup overloading is defined as scheduling backups of multiple primaries onto the same or overlapping time interval on a processor. However, the overloaded backups do exclude a primary which is possible to be scheduled to start earlier. In [4], primary-backup (PB) overloading is proposed to schedule the primary of a task onto the same or overlapping time interval with the backup of another task on a processor. However, a problem of primary-backup overloading is that the time to the second failure occurring (TTSF) is longer than that of backup-backup overloading. TTSF is a measurement of system resiliency which is the time a system takes to recover its ability to tolerate a second fault after the first fault occurs [5]. Smaller the TTSF, better the fault tolerance a system can support. To compromise backup-backup overloading and primary-backup overloading, hybrid overloading has been introduced in [8], [9]. The existence of overloading greatly degrades the flexibility of scheduling and meanwhile limits the number of tasks related through overloading. The existing overloading techniques limit only a few tasks (a few backups in BB overloading, or only a primary and a backup in PB overloading) can be overloaded [3]-[6]. These limits come into being because firstly it is difficult to manage many overloaded tasks and secondly it is unreliable to overload many tasks.

In order to facilitate understanding the present description, some instances are shown as follows. Let prᵢ denote a primary version of a task, bkᵢ denote a backup version of the task and Pᵢ denote a processor. The three overloading schemes are instanced in FIG. 1 and FIG. 2. The left half of FIG. 1 illustrates an example of task scheduling in BB overloading for a case in which three processors P₁ to P₃ are employed while the right half illustrates an example of task scheduling in PB overloading. FIG. 2 illustrates an example of task scheduling in hybrid overloading for a case in which four processors P₁ to P₄ are employed. Since the tasks are connected by the overloading, we simple name the overloaded tasks to be “overloading chain.” There are two overloading chains 121, 122 in FIG. 2. In FIG. 2, if the task pr₁ in the left chain 121 fails, tasks bk₁, bk₂ and pr₃ will survive and tasks pr₂ and bk₃ will be deleted to tolerate the fault in pr₁ to guarantee that at most one task will run on one processor at one instance. After the destruction of the chain, the remaining tasks cannot tolerate a new fault. If the last task in the chain, bk₂, is scheduled to finish very late, the system will be unreliable for a long time. This is the reason why the existing overloading chain is short. Another solution to solve the problem of reliability is to limit an overloading chain in a subset of all processors, and then it is possible to tolerate a new fault in the whole system if the new fault does not happen in a processor in the subset. This solution is named “grouping technique” in [4], [6], which can be classified into static grouping and dynamic grouping.

The fault in this description, i.e., in the context of the present invention, is defined that a processor fails for some reasons such as hardware or software problems and the tasks in the failed processor are lost whether the processor is recovered or not. Thus, the faults can be transient or permanent. The fault is assumed to be detected in time by, for example, a fault detector. At any time instant, only one fault is assumed to happen. For the cases of concurrent faults, we can employ grouping technique [4], [6] to handle the faults and hence we do not consider the cases of concurrent faults.

The fault tolerant method based on the primary and backup scheme with overloading in the related arts has some problems to be solved.

The first problem arises from the pessimism of the existing overloading methods, which only consider a few tasks which can be overloaded together. Although the faults in a supercomputer often happen, the reliability of a single processor or a single computer has been greatly improved since the birth of the first computer. Today it is not ridiculous to assume only one fault within a set of twenty, thirty or more processors or computers. Note that “one fault” means a single fault at any time instant, i.e., no concurrent faults. Even if concurrent faults happen, the loss is still affordable for soft-real-time tasks, compared to the gain of overloading. In real-time multiprocessor systems, time is a kind of resource, which is limited for and shared by tasks. Tasks compete for the time resource. It is essential to improve resource utilization, especially for primary-backup scheme based scheduling because time slots occupied by backups are the price of fault tolerance. Assuming three identical tasks, t₁, t₂, t₃, the primaries pr₁, pr₂, pr₃ and the backups bk₁, bk₂, bk₃ are scheduled in a multiprocessor system. If there is no overloading, the utilization will be

$$\frac{{pr}_{1} + {pr}_{2} + {pr}_{3}}{{pr}_{1} + {pr}_{2} + {pr}_{3} + {bk}_{1} + {bk}_{2} + {bk}_{3}} = \frac{1}{2} .$$

If backup bk₁ is overloaded onto another backup bk₂, then the utilization will be

$$\frac{{pr}_{1} + {pr}_{2} + {pr}_{3}}{{pr}_{1} + {pr}_{2} + {pr}_{3} + {bk}_{2} + {bk}_{3}} = \frac{3}{5} .$$

Similarly, if all backups bk₁, bk₂, bk₃ are in the same time slot, the utilization will be

$$\frac{{pr}_{1} + {pr}_{2} + {pr}_{3}}{{pr}_{1} + {pr}_{2} + {pr}_{3} + {bk}_{3}} = \frac{3}{4} .$$

Obviously more the overloaded tasks, higher the utilization is.

The second problem arises from the attempt to overload more tasks. For example, if we handle tasks by primary-backup overloading and add a new task into the system, we have to check each task in each overloading chain to guarantee that the new task is added in primary-backup overloading. If there are lots of tasks overloaded together, the operation needs much time and the implementation is complex and complicated. Moreover, the new task cannot be added always. For example, in FIG. 1, if we add a new task t₃ into the PB overloading, primary pr₃ must be overloaded onto backup bk₂, and backup bk₃ has to be placed on processor P₂ or P₃. Thus, if the fault happens in processor P₃ (here considering the case in processor P₃) and lasts long enough such that both pr₁ and bk₃ are lost. And then, it is easy to see that the fault cannot be tolerated by deleting some other tasks because finally there is a collision between bk₂ and pr₃ in processor P₁.

The third problem arises from the implementation. Almost all the existing algorithms of fault tolerant task scheduling based on primary and backup scheme are independently designed to meet the task overloading. However, there are lots of real-time scheduling algorithms which are not fault tolerant and cannot be simply made fault tolerant by employing primary and backup scheme. Even if the existing primary and backup based scheduling algorithms are adopted, the management of many overloaded tasks is complicated. Let us consider the overloaded tasks in FIG. 3 in which primaries pr₁ to pr₇ and their backups bk₁ to bk₇ are distributed on eight processors P₁ to P₈. It is complicated to denote the overloaded tasks, to manage the tasks, to tolerate faults and to guarantee the validity of the overloading in a computer program, which has to understand the relation of the overloaded tasks.

### SUMMARY OF INVENTION

As described above, the fault tolerant method based on primary and backup scheme with overloading in the related arts has problems of low utilization of processors, difficulty for adding new tasks and complexity in implementation.

An exemplary object of the present invention is to provide an improved primary-backup based fault tolerant method for multiprocessor systems which can solve the above problems.

Another exemplary object of the present invention is to provide an multiprocessor system carrying out the improved primary-backup based fault tolerant method which can solve the above problems.

According to an exemplary aspect of the present invention, a method of fault tolerance in a multiprocessor system based on primary-backup scheme comprises: receiving a task to be allocated to a processor in a multiprocessor system; allocating a primary version of the task according to a normal real-time scheduling algorithm; checking validity of the allocation of the primary version of the task; allocating a backup version of the task with overloading; and checking validity of the allocation of the backup version of the task.

According to another exemplary aspect of the present invention, a primary-backup based fault tolerant multiprocessor system comprises: a plurality of processors tightly coupled to each other via a bus; a scheduling device scheduling a task and distributing the scheduled task to the processors; and an advising device coupled to the scheduling device, wherein, when the task arrives at the scheduling device, the scheduling device allocates a primary version of the task according to a normal real-time scheduling algorithm and query the advising device, and wherein, when the advising device receives a query from the scheduling device, the advising device checks validity of the allocation of the primary version of the task, allocates a backup version of the task with overloading, and checks validity of the allocation of the backup version of the task.

According to the exemplary aspects of the present invention, a new primary-backup based scheduling method is provided which adds new tasks arbitrarily so long as some simple rules are met, and any existing scheduling algorithm can be made fault tolerant. An existing scheduling algorithm only needs to query an adviser (i.e., advising device or advising process) before to make a decision on a new task allocation. In addition, when a system schedules tasks based on the method of the exemplary aspects of the present invention, the system does not need to understand and remember the relation among overloaded tasks, and hence the resource management is simplified.

The above and other objects, features, and advantages of the present invention will become apparent from the following description based on the accompanying drawings which illustrate exemplary embodiments of the present invention.

### BRIEF DESCRIPTION OF DRAWINGS

FIG. 1 is a timing chart illustrating examples of task scheduling by backup-backup (BB) overloading and primary-backup (PB) overloading.

FIG. 2 is a timing chart illustrating exemplary task scheduling by hybrid overloading.

FIG. 3 is a timing chart illustrating an exemplary complicated case of overloading.

FIG. 4 is a block diagram illustrating an example of a multiprocessor system to which a primary-backup fault tolerant method according to an exemplary embodiment of the invention is applied.

FIG. 5 is a view illustrating transfer of a normal scheduling algorithm to its fault tolerant version.

FIG. 6 is a flowchart illustrating an operation of an advising device (i.e., adviser).

FIG. 7 is a view showing an example of an algorithm of function CPV (Checking Primary Validity).

FIG. 8 is a view showing an example of an algorithm of function CBV (Checking Backup Validity).

FIG. 9 is a view showing an example of an algorithm of procedure FT (Tolerate a fault in a processor).

FIG. 10 is a view showing an example of an algorithm of procedure RTHandler (Recursively Handle Task Sets).

### DESCRIPTION OF EMBODIMENTS

Next, exemplary embodiments according to the present invention will be explained.

Each of the exemplary embodiments is applicable to, for example, a multiprocessor system in which all processors are identical and dedicated. The multiprocessor systems to which the present invention can be applied are not limited to classic real-time systems. The distributed multiprocessor systems or loosely coupled dedicated computing platform are not denied. However, we do not consider here typical P2P (peer-to-peer) or grid computing environments in which resource sharing makes timing constraints much difficult. For a shared memory or a tightly coupled multiprocessor system, we may assume here that tasks are preemptible and migratable since the communication delay is small. Each processor is work-conserving, i.e., no idle processors on which if any task has been allocated. We also assume a central scheduler at which tasks arrive and are scheduled.

FIG. 4 illustrates an example of a multiprocessor system to which the primary-backup fault tolerant method according to the present exemplary embodiment is applied. Illustrated multiprocessor system 100 includes: m pieces of processors P₁ to Pₘ; bus 101 tightly-coupling processors P₁ to Pₘ to each other; shared memory 102 connected to bus 101 and provided in common for all processors P₁ to Pₘ; scheduling device 103 functioning as the central scheduler which generates task schedules for processors P₁ to Pₘ and distributes the tasks to the respective processors; and advising device (i.e., adviser) 104 coupled to scheduling device 103. The tasks to be executed on the processors in a distributed manner arrive first at scheduling device 103 and are then distributed to the processors.

In an example, when scheduling device 103 receives tasks, scheduling device 103 generates task schedules for primary version of the tasks in accordance with an existing normal scheduling algorithm and queries advising device 104 to allocate backup version of the tasks. Alternatively, scheduling device 103 distributes primary and backup versions of tasks to the processors, and queries advising device 104 for allocation of a new task upon the arrival of the new task. In some software implementations, the function of scheduling device 103 and advising device 104 is realized by simply adding an adviser routine to an existing normal scheduling algorithm.

For the purpose of primary-backup based fault tolerant scheme, tasks have the following characteristics (i)-(v):

(i) Tasks are aperiodic, i.e., the task arrivals are not known a priori. Every task tᵢ has the attributes: arrival time (aᵢ), ready time (rᵢ), worst-case computation time (cᵢ), actual computation time (acᵢ) and deadline (dᵢ). The worst-case execution time of a task is obtained based on static code analysis or the average of execution times under possible worst cases. For simplicity, we assume that actual computation time acᵢ is always less than or equal to worst-case execution time cᵢ.

(ii) Each task tᵢ has two versions, namely, primary (prᵢ) and backup (bkᵢ). We assume that all attributes of the two versions are identical.

(iii) Tasks are not parallelizable, which means that a task can be executed on only one processor. This necessitates the sum of worst-case computation times of the primary and backup copies should be less than or equal to (dᵢ−rᵢ) so that both the copies of a task can be schedulable within this interval.

(iv) Tasks are independent. For the tasks with precedence constraints, ready times and deadlines of the tasks can be modified such that they comply with the precedence constraints among them. Dealing with precedence constraints is equivalent to working with the modified ready times and deadlines [10].

(v) After the allocation of a task is decided, the start time and the finish time of this task are known. Let St(tᵢ) denote the start time and Ft(tᵢ) denote the end time of task tᵢ. Let Proc(tᵢ) denote the processor on which task tᵢ is scheduled. Since the two copies, primary and backup, of a task must be scheduled with space and time exclusion, the following rules exist in related work.

rᵢ≦St(prᵢ)<Ft(prᵢ)<St(bkᵢ)<Ft(bkᵢ)≦dᵢ, Rule 1:

Proc(prᵢ)≠Proc(bkᵢ), Rule 2:

if Proc(prᵢ)=Proc(bkⱼ),[St(prᵢ),Ft(prᵢ)]∩[St(prⱼ),Ft(prⱼ)]=φ. Rule 3:

There are many practical systems which are consistent with the system model which we have introduced in the above. For convenience of explanation, we only introduce here an example, a multiprocessor web server, which processes client's requests transmitted by http (hypertext transfer protocol) and often suffers from overload (here “overload” is different from task overloading and only means “too much”). Of course, the present invention can be also applied to multiprocessor systems other than the multiprocessor web server. In the web server, a new task is created when a new request arrives at the server and the new task should be processed in a predetermined time range. If the frequency of arrivals of new requests increases too much, the server will be overloaded.

When overload happens in a web server which tries to guarantee the deadlines of requests (packets), the server should guarantee all admitted requests and simultaneously fully utilize the system capacity. If a request cannot be guaranteed, then the request should be rejected and moves to another server.

The primary-backup based fault tolerant scheme with overloading according to an exemplary embodiment includes following operations and conditions (1)-(20).

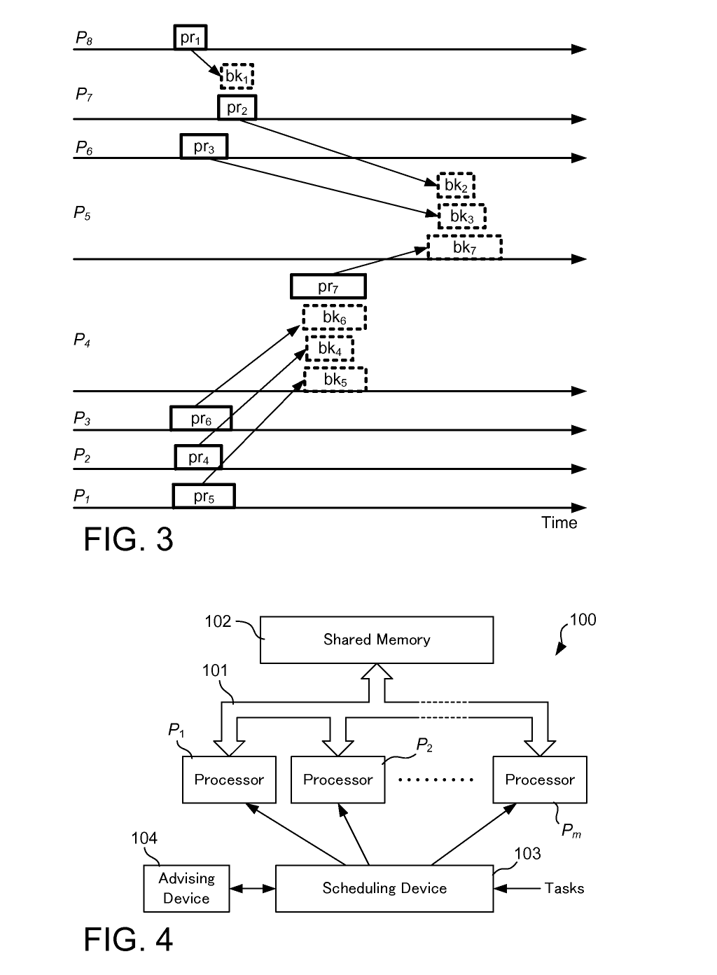

(1) Tasks are managed through task sets, one of which is defined to be a set of tasks overloaded together. In FIG. 3, for example, a task set includes pr₄,pr₅,pr₆ and another task set includes pr₇, bk₄, bk₅, bk₆. Task set is denoted by τ.

(2) Define ∀tᵢ ∈ τ,∀t_{j≠i} ∈ τ,δ=Min(|[St(tᵢ),Ft(tᵢ)]∩[St(tⱼ),Ft(tⱼ)]|), and |·| is the length of time. Define ∃tₖ ∉ τ,∀tᵢ ∈ τ,δ(tₖ,τ)=Min(|[St(tₖ),Ft(tₖ)]∩[St(tᵢ),Ft(tᵢ)]|).

(3) Define St(τ)=min{St(tᵢ)|∀tᵢ ∈ τ} and Ft(τ)=max{Ft(tᵢ)|∀tᵢ ∈ τ}.

(4) Just like that a task tᵢ could be its primary version prᵢ or its backup version bkᵢ, a task set τᵢ could be one of the following three types, π, β and η. A task set of π-type only contains primary version of tasks, a β-type task set only contains backups, and an η-type task set contains primary and backups.

(5) A single task is also a task set and this task must be a π-type task set.

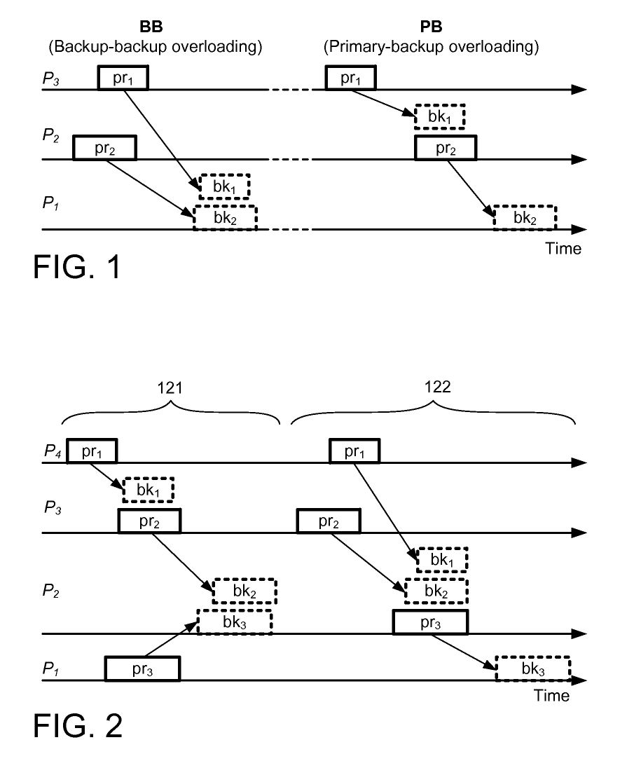

(6) As shown in FIG. 1, FIG. 2 and FIG. 3, the relation of overloaded tasks is just the relation of the task sets. The related tasks are organized to be a family of task sets, defined to be S.

(7) Family S could also be one of the following types, II, B and F. Family of II-type indicates a pure primary-backup (PB) overloading as in FIG. 1 while family of B-type indicates a pure backup-backup (BB) overloading as in FIG. 1. Family of F-type indicates a free overloading as in FIG. 3. Note that the difference between “free overloading” and “hybrid overloading” is that hybrid overloading needs to decide and understand the specific relation of tasks in scheduling and managing.

(8) A new rule is added to guarantee that the overloading is valid as follows:

∀τᵢ ∈ S, ∀τ_{j≠i} ∈ S, Proc(τᵢ)≠Proc(τⱼ). Rule 4:

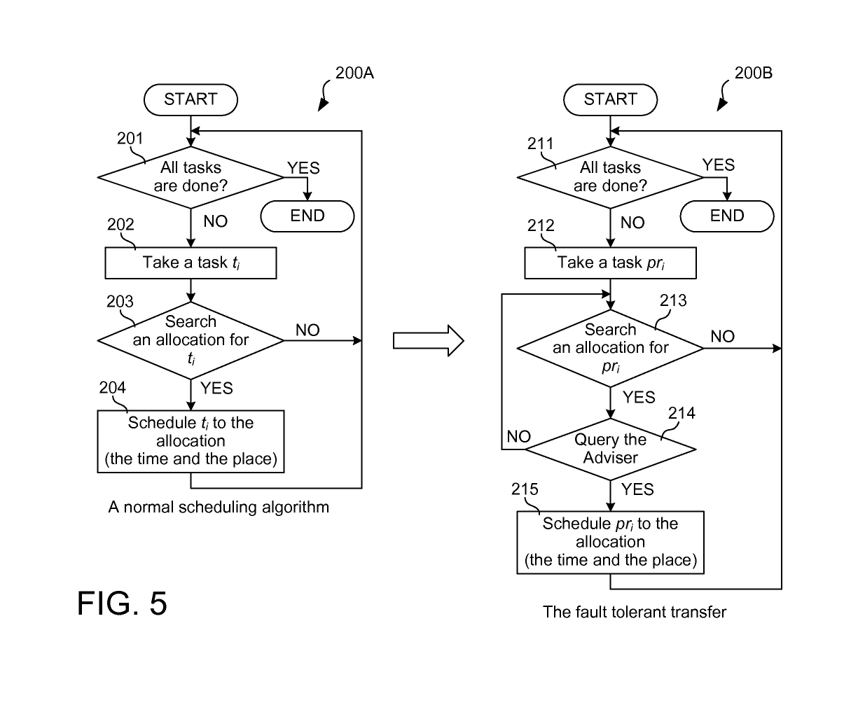

(9) The exemplary embodiment does not include a specific task scheduling algorithm, but does support existing scheduling algorithms, which should schedule one task by another one task as, for example, procedure shown in FIG. 5. FIG. 5 illustrate an example of transfer of a normal scheduling algorithm to its fault tolerant version, and includes flowchart 200A showing a normal scheduling algorithm and flowchart 200B showing the fault tolerant version derived from the normal scheduling algorithm.

In the normal scheduling algorithm shown in flowchart 200A, first in step 201, it is checked whether all tasks have been done or not. If done, the process of the algorithm terminates, otherwise, task tᵢ is taken at step 202 as a task to be processed next and the process goes to step 203. In step 203, an allocation for task tᵢ is searched. If an allocation for task tᵢ is found, then task tᵢ is spatially and temporally scheduled to the allocation in step 204, and the process returns to step 201. If no allocation is found at step 203, then the process directly returns to step 201.

In the algorithm of fault tolerant version shown in flowchart 200B, first in step 211, it is checked whether all tasks have been done or not. If done, the process of the algorithm terminates, otherwise, primary task prᵢ is taken at step 212 as a task to be processed next and the process goes to step 213. In step 213, an allocation for primary task prᵢ is searched. If an allocation for primary task prᵢ is found, then the adviser is asked for allocation of backup task bkᵢ in step 214. If the allocation of backup task bkᵢ is successful, then task prᵢ is spatially and temporally scheduled to the allocation in step 215 and the process returns to step 211. If no allocation for primary task prᵢ is found at step 213, then the process directly returns to step 211. If allocation for backup task bkᵢ is not successful at step 214, then the process returns to step 213.

When a task is being scheduled, the scheduling algorithm shown in flowchart 200A is slightly modified to ask the adviser to confirm the task allocation found by the scheduling algorithm is correct and fault tolerant. FIG. 5 shows the basic idea of using the adviser. Obviously, it is not necessary to do a big operation in the normal scheduling algorithm.

(10) The adviser checks the allocation of a primary and then chooses a suitable allocation for its backup. If any one, the primary or the backup, cannot be accepted by the adviser, then the task should be rejected and then the next task will be considered. Since the adviser does not interfere with the core of the scheduling and searching allocations, any scheduling algorithm which is modeled by flowchart 200A in FIG. 5 can be transferred to its fault tolerant version shown in flowchart 200B.

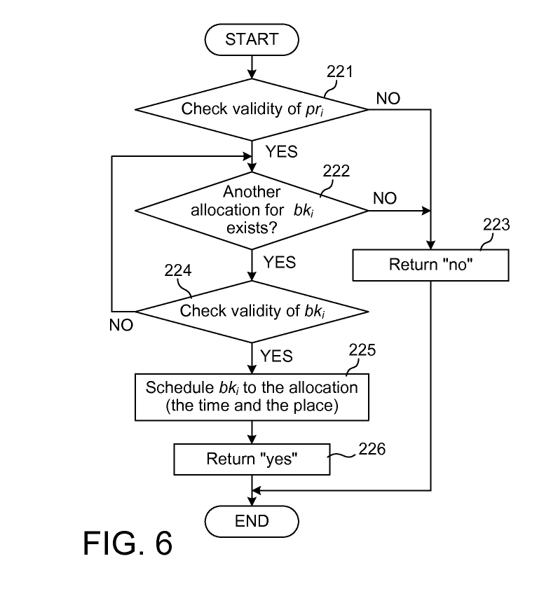

The operation of the adviser is illustrated in FIG. 6. According to the flowchart shown in FIG. 6, the advisor first checks the validity of allocation of task prᵢ at step 221. If the allocation is invalid, the process goes to step 223 to return “no” and then terminates. If the allocation for task prᵢ is valid, the advisor searches, at step 222, another possible allocation for backup bkᵢ. If no allocation is found, the process goes to step 223 to return “no” and then terminates. If another allocation exists in step 222, then the advisor checks the validity of allocation of task bkᵢ at step 224. If invalid, then the process returns to step 222. If valid in step 224, the advisor spatially and temporally schedules task bkᵢ to the allocation in step 225, and the process goes to step 226 to return “yes” and then terminates.

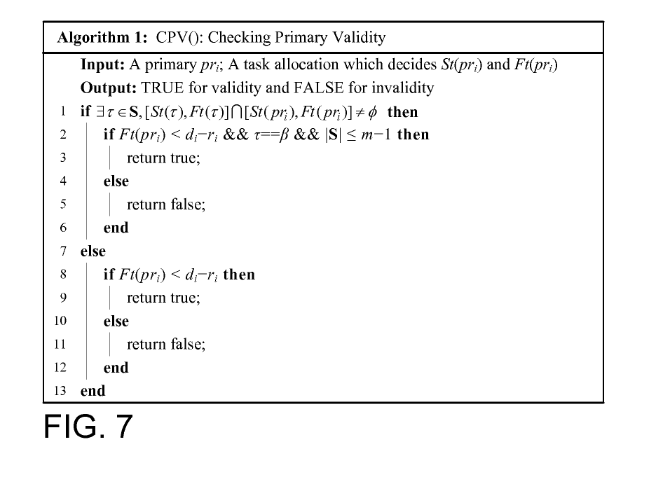

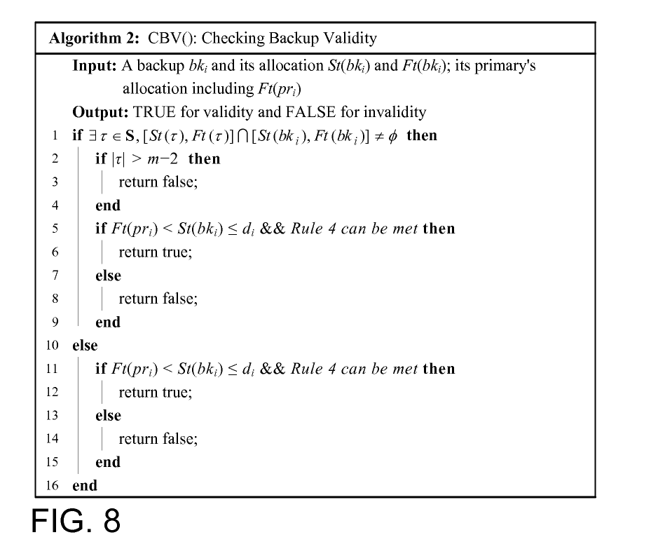

(11) In the present exemplary embodiment, checking validity of primary or backup allocation is much simpler than the existing techniques, because it is sufficient to guarantee the validity by only checking whether the above four rules, i.e., Rule 1, Rule 2, Rule 3 and Rule 4, can be met or not. On the contrary, the existing techniques have to understand the relation of overloaded tasks. The pseudo-code of checking validity is shown in FIG. 7 and FIG. 8. FIG. 7 illustrates function CPV( ) which is used for checking validity of primary allocation while FIG. 8 illustrates function CBV( ) which is used for checking validity of backup allocation.

(12) Rule 4 can be examined by the following technique. Assuming that the multiprocessor system has m pieces of processors, an m-bit binary number k is used for family S to denote the processors which family S has visited. It is assumed that the most significant bit (MSB) of binary value k corresponds to the first processor P₁ and the visiting states of successive processors are indicated in the successive bits in the binary value. Therefore, the least significant bit (LSB) corresponds to m^{th} processor Pₘ. For example, if task sets contained in family S have visited processors P₂, P₃, P₅ and P₆ and there are eight processors P₁ to P₈ in the system, then k=01101100. A new task set is accepted to processor P₁, and then k=11101100. To check Rule 4, it is sufficient to verify whether 01101100 [symbol] 1000000=0 or not. To update k, it is sufficient to perform operation of k=01101100 [symbol] 1000000. In this example, the verification of Rule 4 is based on a logical “AND” operation and the updating is based on a logical “OR” operation. The operations of verifying and updating k are omitted in the figures and we only say to meet Rule 4 for simplicity. Adding a new task may connect two separated families S₁ and S₂. The method mentioned in the above is also suitable to check whether families S₁ and S₂ can be connected or not.

(13) The adviser should decide the most feasible allocation for primaries. The adviser tries to reduce the interference on primaries from scheduling backups. Only if a time slot selected for a primary passes CPV( ), the primary will be allocated to the time slot. When the scheduling algorithm searches the allocations for a primary, only a π-type set and an η-type set are in consideration and a β-type set is invisible for the primary.

(14) Scheduling backups is different from scheduling primaries, because backups actually are “ghosts” and can be overloaded on others. If backups would not interfere with the scheduling of primaries, fault tolerance would be at no cost. Hence, the interference due to backups should be controlled to be the minimum. Backup task bkᵢ should basically be allocated within [Ft(prᵢ), dᵢ]. Thus, it is necessary to consider each time slot [Ft(prᵢ), dᵢ] in Pⱼ, Pⱼ≠Proc(prᵢ) (note that, under this condition, the allocation of this backup may be invalid and the validity is checked by CBV( )).

(15) Time length λ of a task set is defined to be ∀τᵢ ∈ S, λ=[Min(St(τᵢ)),Max(Ft(τᵢ))]. Time length bound A is a user parameter. In both validity checking functions CPV( ) and CBV( ), the time length will be checked. If the time length λis greater than the time length bound Λ, the task cannot pass the validity checking. Checking time length is omitted in the related figures for its simplicity.

(16) The adviser should also decide the most feasible allocation for backups. In an exemplary embodiment, a policy may be also provided for backups. Either a backup is tried to take an empty time slot as late as possible or a backup is tried to be allocated to existing task sets. If there are more than one task sets {τ₁,τ₂,τ₃ . . . } passing CBV( ), a task set τ is chosen for task bkₖ if δ(bkₖ,τ)=max{δ(bkₖ,τᵢ)|∀τᵢ}. A user parameter is used to decide where to allocate a backup.

(17) Weight of tightness ω, which is the user parameter, may be introduced. If there is no task set into which task bkₖ can be overloaded, certainly δ(bkₖ,τ)=0 and the backup is scheduled to an empty time slot as late as possible. If δ(bkₖ,τ)≠0, then it is checked whether is δ(bkₖ,τ) greater than ω or not. If δ(bkₖ,τ)>ω, then the backup is overloaded to task set τ. If δ(bkₖ,τ)≦ω and there is no empty time slot, then the backup is also overloaded to task set τ. If τ(bkₖ,τ)≦ω and there is an empty time slot, then the backup is scheduled to the empty time slot.

(18) Dynamics of β may also be introduced. When a task is going to be overloaded into a task set, we hope that the overloading is as tight as possible and at least the weight of tightness is not less than ω. Thus, when a task tₖ, a primary or a backup, is going to be overloaded to a task set, a β, the β will be moved forward to increase δ(tₖ,β). The dynamics of β may be embedded in the adviser and is not explicitly shown in the figures.

(19) When a fault happens, the failed task sets are treated by a recursive algorithm to tolerate the fault. If the tasks are scheduled fully in terms of (1)-(17), each family S is a rooted and directed tree. The root is a β-type task set. All leaves are π-type task sets. All internal vertices are η-type task sets, if the internal vertices exist.

All conditions and operations in (1)-(18) have been proved mathematically to be correct.

(20) If a family S collapses, the task sets in family S will not directly degrade to tasks, and instead, family S is first tried to be decomposed into several independent families S. Only if no new S can be reorganized, the task sets will be degraded to separated tasks.

(21) It is possible to introduce procedure revs( )which is an operation which turns a primary or a backup to its backup or primary, respectively. To find a new allocation for a backup is to search the processors for an allocation which is empty or occupied by a task set. Note that CBV( ) is invoked for the new allocation and CBV( ) must check whether two separated families S can be connected as in above item (12).

Next, we will explain the contributions provided by the fault tolerant method according to the above exemplary embodiments.

First, a new overloading technique is proposed in order to casually overload tasks only under some simple conditions and without the knowledge of the relations of tasks in the schedule. In this way, the primary-backup scheme and the casual overloading are isolated from the scheduling of primaries, and consequently various real-time scheduling algorithms can be simply made fault tolerant by employing the adviser which can respond to the task schedulers with the information of whether or not the allocation of tasks is fault tolerant and meanwhile correctly schedule the corresponding backup.

Second, the management of tasks, primaries and backups is formalized, and then through carefully studying the casual overloading, a series of algorithms is developed to manage task overloading and fault tolerating, and meanwhile the algorithms are designed to repair the overloading after a fault is tolerated by decomposing and recomposing the overloading.

The whole or part of the exemplary embodiments disclosed above can further include, but are not limited to, the following variants.

Variant 1:

A method of supporting fault tolerance in multiprocessor systems based on primary-backup scheme is provided. The method includes some key sub-methods including: a method of transferring a normal real-time scheduling algorithm to its fault tolerant version; an adviser which answers a normal algorithm for task allocations and overloading; and a method of tolerating faults.

Variant 2:

A method of transferring a normal real-time scheduling algorithm to its fault tolerant version as described in Variant 1 is provided. This method does not change the original algorithm and only adds the adviser or advisor algorithm, as known in Variant 1, to the original scheduling algorithm. All normal real-time scheduling algorithms which can be represented in the manner as shown in flowchart 200A in FIG. 5 is possible to be transferred to the fault-tolerant version by this method. The method includes the characteristics of: managing tasks as task sets; managing the task sets as rooted and directed trees; and using the adviser to avoid interfering the normal scheduling algorithm too much.

Variant 3:

The method managing tasks in Variant 2 is modified such that each task is managed as a task set. A task set can contain many tasks. According to the types of tasks in a task set, the task sets can be classified into different types. The task sets are also managed as different sets, known as the families of task sets. Adding a new task is equal to extend the family. Tolerating a fault is equal to decomposing the family. A family of task sets can be decomposed to be separated families of task sets and different families of task sets are possible to be connected to be a single family of task sets.

Variant 4:

The families of task sets are managed as a fault tolerant tree which has the structure similar to that described in Variant 2. The fault tolerant tree is a rooted and directed tree. The root, the internal vertices and the leaves are different types of task sets.

Variant 5:

The adviser described in any one of Variants 1 and 2 answers the query from the original normal algorithm for checking validity of overloading and meanwhile schedules backups. The adviser performs the processing of: deciding the validity of overloading simply by some rules; and scheduling the backups.

Variant 6:

The method of deciding the validity of overloading in Variant 5 includes the algorithm CPV( ) illustrated in FIG. 7 and algorithm CBV( ) illustrated in FIG. 8. These algorithms have the important steps which verify whether or not all the rules can be met, especially verification of Rule 4. If any rule cannot be met, the corresponding task should be rejected.

Variant 7:

Verification of Rule 4 in Variant 6 includes encoding the processors into a key, a binary number, which has the length equal to the number of the processors. To verify Rule 4 is to perform an “AND” operation on two binary numbers. If the result of the “AND” operation is “0,” Rule 4 is satisfied and otherwise is not satisfied. If a task set is added into a family of task sets, the key is updated by an “OR” operation performed on the two binary numbers. To connect two separate families of task sets is also based on this technique.

Variant 8:

The backups are scheduled according to a method which includes: (i) deciding whether scheduling backups as late as possible or overloading backups to previous task sets as tight as possible, according to different conditions on the weight of tightness; (ii) maximizing the tightness by moving backups according to Variant 1. This method makes decisions on scheduling backups as late as possible or overloading backups as tight as possible. The method further includes (iii) controlling the time length of any task set to be less than the time length bound defined by a user.

Variant 9:

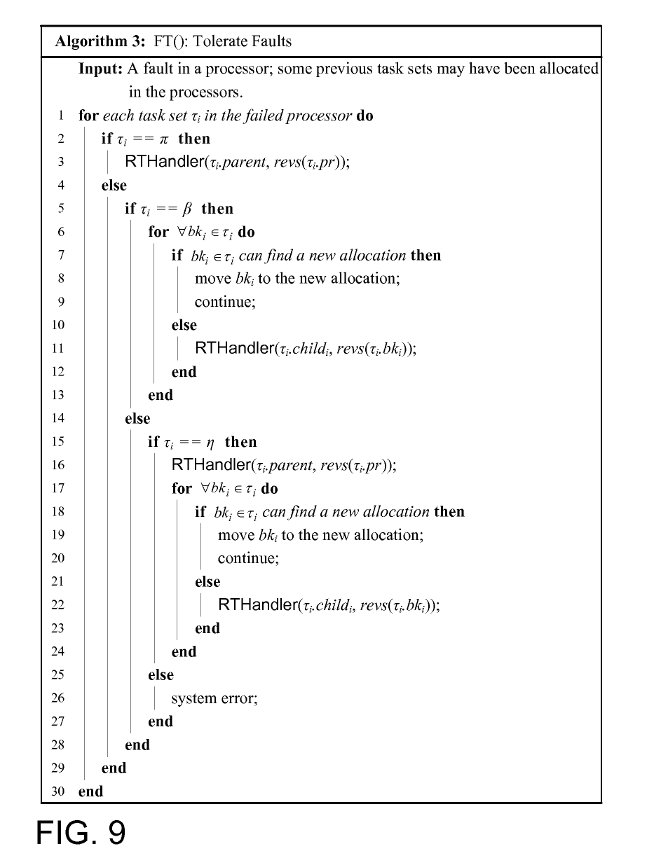

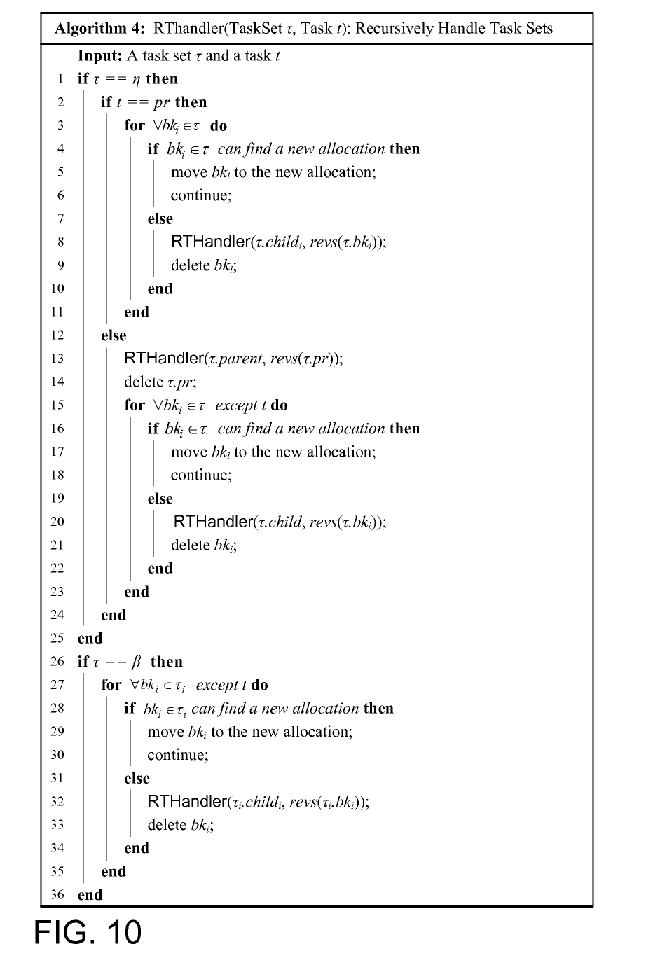

A method of tolerating faults based on Variant 1 includes: managing tasks as task sets; tolerating fault for each processor; recursively handling the task sets; and recomposing overloading. An example of algorithm of tolerating faults is shown in FIG. 9 which illustrates a pseudo-code of procedure FT( ). The algorithm shown in FIG. 9 assumes a fault in a processor and includes all branching conditions and steps including call for RTHandler (algorithm for recursively handling the task sets). The pseudo-code of RTHandler is shown in FIG. 10 which includes all branching conditions and steps. In the algorithms, a method is embedded which tries to recompose the set of task sets into separate sets when a fault happens.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### REFERENCES

[1] I. Korean and C. M. Krishna, Fault-Tolerant Systems, Morgan Kaugmann, Elsevier, 2007.

[2] C. M. Krishna and K. G. Shin, “On Scheduling Tasks With Quick Recovery From Failure,” IEEE Trans. Computer, 35(5):448-455, 1986.

[3] R. Al-Omari, A. K. Somani and G. Manimaran, “An adaptive scheme for fault-tolerant scheduling of soft real-time tasks in multiprocessor systems,” J. Parallel and Distributed Computing, 65(5):595-608, 2005.

[4] R. Al-Omari, A. K. Somani and G. Manimaran, “Efficient overloading techniques for primary-backup scheduling in real-time system,” J. Parallel and Distributed Computing, 64(5):629-648, 2004.

[5] S. Ghosh, R. Melhem and D. Mosse, “Fault-tolerance through scheduling of aperiodic tasks in hard real-time multiprocessor systems,” IEEE Trans. Parallel Distributed Systems, 8(3):272-284, 1997.

[6] G. Manimaran and C. Siva Ram Murthy, “A fault-tolerant dynamic scheduling algorithm for multiprocessor real-time systems and its analysis,” IEEE Trans. Parallel Distributed Systems, 9(11):1137-1152, November 1998.

[7] K. Hashimoto, T. Tsuchiya, and T. Kikuno, “A New Fault-Tolerant Scheduling Technique for Real-Time Multiprocessor Systems,” J. Systems and Software, 53(2), pp. 159.171, 2000.

[8] W. Sun, Y. Zhang, X. Defago, et al., “Real-time Task Scheduling Using Extended Overloading Technique for Multiprocessor Systems,” IEEE Int'l Symp. Distributed Simulation and Real Time Applications, pp. 95-102, 2007.

[9] W. Sun, Y. Zhang, X. Defago, et al., “Hybrid Overloading and Stochastic Analysis for Redundant Scheduling in Real-time Multiprocessor Systems,” IEEE Int'l Symp. Reliable Distributed Systems, pp. 265-274, 2007.

[10] J. W. S. Liu, W. K. Shih, K. J. Lin, R. Bettati and J. Y. Chung, “Imprecise Computations,” Proc. IEEE, vol. 82, no. 1, pp. 83-94, January 1994.

[11] B. Andersson, T. Abdelzaher, J. Jonsson, “Partitioned Aperiodic Scheduling on Multiprocessors,” Proc. Int'l Parallel and Distributed Processing Symp., 2003.

What is claimed is:

1. A method of fault tolerance in a multiprocessor system based on primary-backup scheme, the method comprising:
receiving a task to be allocated to a processor in a multiprocessor system;
allocating a primary version of the task according to a normal real-time scheduling algorithm;
checking validity of the allocation of the primary version of the task;
allocating a backup version of the task with overloading;
checking validity of the allocation of the backup version of the task.

2. The method according to claim 1, wherein the checking validity of the allocation of both the primary and backup versions and allocating the backup version are carried out in an adviser when the advisor is asked by a scheduler, the adviser being separately provided from the scheduler, and the scheduler allocating the primary version of the task.

3. The method according to claim 1, further comprising tolerating a fault using the backup version when the fault happen in a processor corresponds to the primary version.

4. The method according to claim 1, wherein when the at least one of the validity of the allocation of the primary version and the validity of the allocation of the backup version is denied, the corresponding task is rejected.

5. The method according to claim 2, wherein the tasks are managed as at least one task set, each task set being a set of tasks which are overloaded together, the task sets are treated as rooted and directed trees, and the advisor allocates the backup version using the task sets to avoid interfering the normal scheduling algorithm too much.

6. The method according to claim 2, wherein the tasks are managed as at least one task set, each task set being a set of tasks which are overloaded together, and
wherein, if there is a task set into which the backup version can be overloaded and a predetermined condition is met, the adviser schedules the backup version such that the backup version is overloaded to an existing task set as tight as the existing task set, otherwise the adviser schedules the backup version to an empty time slot as late as possible.

7. The method according to claim 6, wherein the adviser controls a time length of any task set to be less than a time length bound defined by a user.

8. The method according to claim 5, wherein the task sets are managed at least one family, each family being a set of task sets, and a fault is tolerated by decomposing the family.

9. The method according to claim 3, wherein the tasks are managed as at least one task set, each task set being a set of tasks which are overloaded together, and
wherein the tolerating includes: recursively handling the task sets; and recomposing the overloading.

10. A primary-backup based fault tolerant multiprocessor system comprising:
a plurality of processors tightly coupled to each other via a bus;
a scheduling device scheduling a task and distributing the scheduled task to the processors; and
an advising device coupled to the scheduling device,
wherein, when the task arrives at the scheduling device, the scheduling device allocates a primary version of the task according to a normal real-time scheduling algorithm and query the advising device, and
wherein, when the advising device receives a query from the scheduling device, the advising device checks validity of the allocation of the primary version of the task, allocates a backup version of the task with overloading, and checks validity of the allocation of the backup version of the task.

11. The method according to claim 2, further comprising tolerating a fault using the backup version when the fault happen in a processor corresponds to the primary version.

12. The method according to claim 2, wherein when the at least one of the validity of the allocation of the primary version and the validity of the allocation of the backup version is denied, the corresponding task is rejected.

13. The method according to claim 3, wherein when the at least one of the validity of the allocation of the primary version and the validity of the allocation of the backup version is denied, the corresponding task is rejected.

14. The method according to claim 11, wherein the tasks are managed as at least one task set, each task set being a set of tasks which are overloaded together, and
wherein the tolerating includes: recursively handling the task sets; and recomposing the overloading.

15. A primary-backup based fault tolerant multiprocessor system in which a plurality of processors are tightly coupled to each other via a bus, the system comprising:
scheduling means for scheduling a task and distributing the scheduled task to the processors; and
advising means for, when the advising means receives a query from the scheduling means, checking validity of allocation of a primary version of the task, allocating a backup version of the task with overloading, and checking validity of allocation of the backup version of the task,
wherein the advising means is coupled to the scheduling means, and
when the task arrives at the scheduling means, the scheduling means allocates the primary version of the task according to a normal real-time scheduling algorithm and query the advising means.
